(19) United States
(12) Patent Application Publication
(10) Pub. No.: US 2012/0318197 A1
(43) Pub. Date: Dec. 20, 2012

(54) SPIRAL COATING APPARATUS AND SPIRAL COATING METHOD

(76) Inventors: Kenichi Ooshiro, Yokohama-shi (JP); Tsuyoshi Sato, Yokohama-shi (JP)

(21) Appl. No.: 13/528,012

(22) Filed: Jun. 20, 2012

(30) Foreign Application Priority Data
Jun. 20, 2011 (JP) 2011-136354

(51) Int. Cl. B05C 11/08

(52) U.S. Cl. 118/712

(57) ABSTRACT

According to one embodiment, a spiral coating apparatus includes a stage, a rotation mechanism, a coating nozzle, a movement mechanical unit, a nozzle position detection unit, and a position adjustment unit. The movement mechanical unit enables the stage and the coating nozzle to relatively move across the rotational direction and in the direction of the axis of the rotation. The nozzle position detection unit is configured to acquire positional data on a bottom surface of the coating nozzle in the direction of the axis of the rotation. The position adjustment unit adjusts the positions of the coating nozzle and the surface in the direction of the axis.

### CROSS-REFERENCE TO RELATED APPLICATIONS

This application is based upon and claims the benefit of priority from prior Japanese Patent Application No. 2011-136354, filed Jun. 20, 2011, the entire contents of which are incorporated herein by reference.

### FIELD

Embodiments described herein relate generally to a spiral coating apparatus and a spiral coating method, and more specifically, to a spiral coating apparatus and a spiral coating method in which a material is applied to an object to be coated to form a coating film thereon.

### BACKGROUND

A spiral coating method is a known method for forming a circular film on a substrate used in the field of semiconductors. According to this spiral coating method, a disk-like substrate is secured to the top of a circular rotary stage, and the distance (gap) between the discharge surface of a coating nozzle and a surface of the substrate is kept at a predetermined value. The rotary stage is rotated as a material is discharged from the coating nozzle by a constant-volume pump. As this is done, the coating nozzle is moved straight from the center of the substrate toward the outer periphery of the substrate, describing a spiral application locus to form a film over the entire surface of the substrate.

According to a spiral coating apparatus and method, the distance to the substrate surface is measured by means of, for example, a displacement sensor integral with the nozzle. Gap control is performed to keep the distance between the tip of the nozzle and the substrate surface constant by adjusting the vertical position of the nozzle so that the measured distance is at a preset value.

The position of the discharge surface of the nozzle may be changed by the influence of, for example, the reproducibility of the movement of the nozzle, dimensional variation, thermal expansion of the nozzle, etc. In such a case, it is difficult to highly precisely control the gap by the above-described technique.

### BRIEF DESCRIPTION OF THE DRAWINGS

FIG. 1 is a schematic explanatory diagram showing a configuration of a spiral coating apparatus according to a first embodiment;

FIG. 2 is a flowchart showing control procedure of a spiral coating method according to the embodiment;

FIG. 3 is an explanatory diagram showing a stage position detection process of the spiral coating method;

FIG. 4 is an explanatory diagram showing the stage position detection process of the spiral coating method;

FIG. 5 is an explanatory diagram showing a nozzle position detection process of the spiral coating method;

FIG. 6 is an explanatory diagram showing the nozzle position detection process of the spiral coating method;

FIG. 7 is a schematic explanatory diagram showing a configuration of a coating apparatus according to a second embodiment;

FIG. 8 is a flowchart showing control procedure of the coating apparatus;

FIG. 9 is a schematic explanatory diagram showing a configuration of a coating apparatus according to a third embodiment; and

FIG. 10 is a flowchart showing control procedure of the coating apparatus.

### DETAILED DESCRIPTION

In general, according to one embodiment, a spiral coating apparatus comprises a stage, a rotation mechanism, a coating nozzle, a movement mechanical unit, a nozzle position detection unit, and a position adjustment unit. The stage comprises a mounting surface on which an object to be coated is placed. The rotation mechanism is configured to rotate the stage in a rotational direction along the mounting surface. The coating nozzle configured to discharge a material onto the object to be coated on the stage, thereby coating the object. The movement mechanical unit enables the stage and the coating nozzle to relatively move in a cross direction across the rotational direction along the mounting surface and in the direction of the axis of the rotation. The nozzle position detection unit is configured to acquire positional data on a bottom surface of the coating nozzle in the direction of the axis of the rotation. The position adjustment unit is configured to adjust the positions of the coating nozzle and the mounting surface in the direction of the axis based on the positional data on the coating nozzle.

### First Embodiment

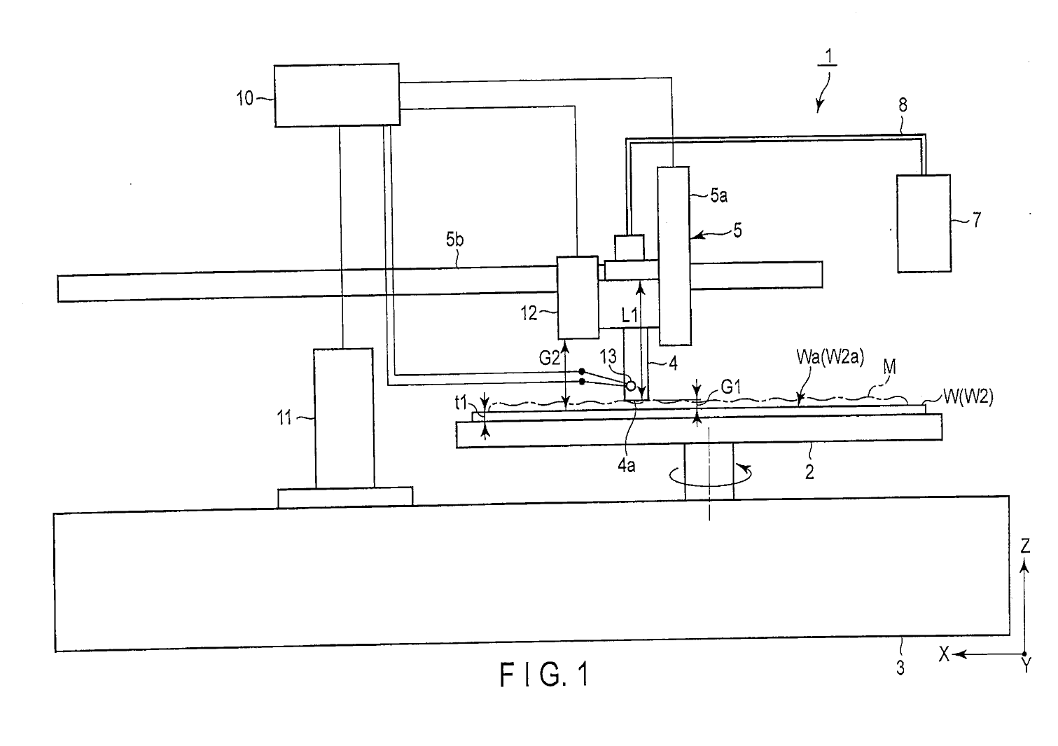

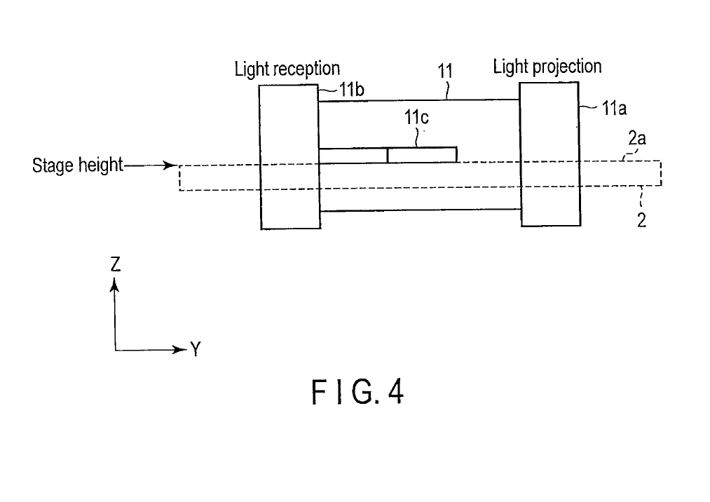

A spiral coating apparatus 1 and a spiral coating method according to a first embodiment of the present invention will now be described with reference to FIGS. 1 to 6. In these drawings, arrows X, Y and Z indicate three orthogonal directions, and several structural elements are increased or reduced in scale or omitted for ease of illustration.

The spiral coating apparatus 1 shown in FIG. 1 comprises a stage 2, rotation mechanism 3, coating nozzle 4, movement mechanism (movement mechanical unit) 5, and supply unit 7. A substrate W as an object to be coated can be placed on the stage 2. The rotation mechanism 3 rotates the stage 2 in a horizontal plane. The coating nozzle 4 discharges a material through its tip and applies it to the substrate W on the stage 2. The movement mechanism 5 enables the coating nozzle 4 and stage 2 to relatively move in a horizontal (X-axis) direction and vertical (Z-axis) direction. The supply unit 7 supplies the coating material to the coating nozzle 4. The apparatus 1 further comprises a line sensor (position detection unit) 11, displacement sensor (position detection unit) 12, temperature sensing unit 13, and control unit (position adjustment unit) 10 for controlling all these parts or units.

The stage 2 is, for example, a circular structure that can be rotated in a horizontal plane by the rotation mechanism 3. The stage 2 comprises a suction mechanism configured to attract the substrate W placed thereon. The suction mechanism secures and holds the substrate W on a mounting surface 2a of the stage 2. The suction mechanism used may be an air suction mechanism, for example.

The rotation mechanism 3 supports the stage 2 for rotation in the horizontal plane, and causes a drive source, such as a motor, to rotate the stage 2 about its axis in the horizontal plane. Thus, the substrate W on the stage 2 can rotate in the horizontal plane.

The coating nozzle 4 is a nozzle for discharging the material to form a coating film M and comprises a nozzle surface 4a on its tip (bottom surface). The coating nozzle 4 continuously discharges the material through its tip 4a under pressure and applies it to the substrate W on the stage 2.

The supply unit 7 for supplying the material is connected to the coating nozzle 4 through the passage of a communicating tube 8. The supply unit 7 comprises a supply tank storing the material, supply pump, flow control valve, etc. The supply unit 7 is controlled by the control unit 10, whereby the material discharge from the coating nozzle 4 is adjusted. In a coating process, the material is supplied from the supply tank to the coating nozzle 4 as the supply pump is activated. The communicating tube 8 is formed of, for example, a tube or pipe, which internally connects the coating nozzle 4 and the supply tank of the supply unit 7.

The nozzle 4 comprises the temperature sensing unit 13, which is located on, for example, the sidewall of the nozzle 4. The temperature sensing unit 13 is a temperature sensor such as a thermocouple, which detects the temperature of the sidewall of the nozzle 4, thereby determining the nozzle temperature, and delivers temperature data to the control unit 10.

The movement mechanism 5 comprises a Z-axis movement mechanism 5a, which supports and moves the coating nozzle 4 in the Z-axis direction, and an X-axis movement mechanism 5b, which supports the nozzle 4 through the Z-axis movement mechanism 5a and moves it in the X-axis direction. The movement mechanism 5 locates the nozzle 4 above the stage 2 and moves the nozzle 4 relative to the stage 2. The Z- and X-axis movement mechanisms 5a and 5b used may be, for example, linear-motor movement mechanisms with a linear motor as a drive source, feed-screw movement mechanisms with a motor, etc.

The line sensor 11 as a position detection unit is disposed beside the stage 2. The line sensor 11 comprises, for example, a light projecting unit 11a, light sensing unit 11b, and position detection plate 11c. The position detection plate 11c horizontally extends toward the stage 2 and is vertically movable.

The line sensor 11 emits light from its light projecting unit 11a with the position detection plate 11c vertically moved to abut the upper surface of the stage 2. Based on data on light received by the light sensing unit 11b through the detection plate 11c, the line sensor 11 acquires positional data on the detection plate 11c. Based on this positional data, the line sensor 11 acquires Z-direction positional data (height data) with respect to the mounting surface 2a of the stage 2 and delivers it to the control unit 10.

Based on data on the light emitted from the light projecting unit 11a and received by the light sensing unit 11b through the nozzle 4 located within a predetermined range of measurement, moreover, the line sensor 11 acquires Z-direction positional data on the nozzle surface 4a and delivers it to the control unit 10.

The movement mechanism 5 comprises the stage displacement sensor 12 as well as the coating nozzle 4. When the movement mechanism 5 is activated, both the nozzle 4 and displacement sensor 12 can move in the X- and Z-directions.

The displacement sensor 12 is, for example, a reflective laser sensor, which is moved together with the Z-axis movement mechanism 5a in the X-axis direction by the X-axis movement mechanism 5b. The displacement sensor 12 measures the clearance from the mounting surface 2a of the stage 2 or a substrate W2 for adjustment located opposite thereto by detecting light applied to the mounting surface 2a or substrate W2. In this way, the displacement sensor 12 acquires Z-direction positional data on the mounting surface 2a or substrate W2 and delivers it to the control unit 10.

The control unit 10 comprises a microcomputer for intensively controlling various parts and a storage unit that stores various programs and data. A memory or hard disk drive (HDD) is used as the storage unit.

The control unit 10 determines a gap value and correction value by arithmetic processing based on, for example, various programs and data (positional data, temperature data, etc.). Further, the control unit 10 functions as a position adjustment unit that controls the rotation mechanism 3 and movement mechanism 5, based on, for example, various programs and data (coating condition data, etc.), and positions the coating nozzle 4 above the stage 2 with a predetermined gap therebetween. Furthermore, the control unit 10 rotates the stage 2 with the substrate W thereon and causes the nozzle 4 to discharge the material through the tip 4a as the nozzle 4 is linearly moved from the center (or outer periphery) of the substrate toward the outer periphery (or center). Thereupon, a spiral application locus is described to form a film over the entire surface of the substrate (spiral coating).

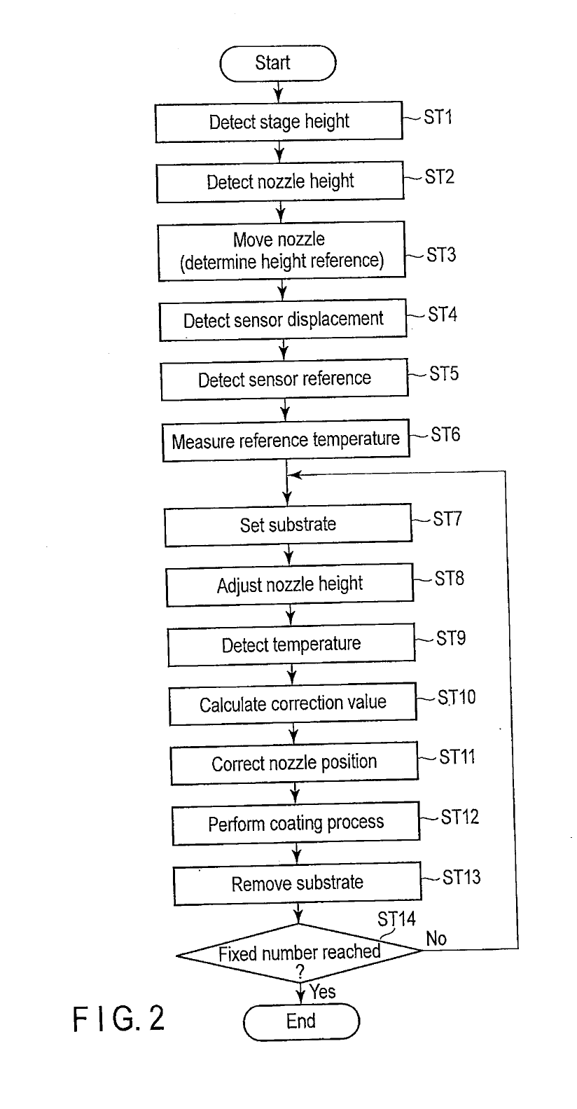

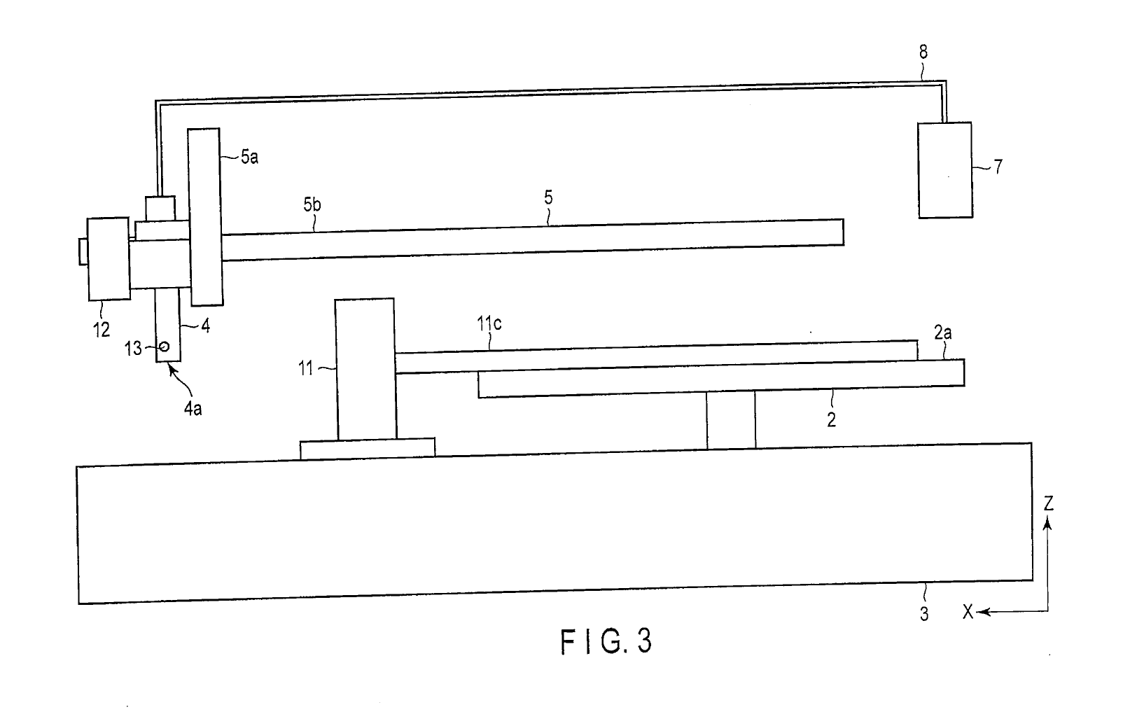

The operation of the coating apparatus 1 will now be described with reference to FIG. 2. The control unit 10 first acquires height data on the upper surface of the stage 2 by means of the line sensor 11 (ST1). As shown in FIGS. 2 and 3, for example, light is emitted from the light projecting unit 11a with the detection plate 11c vertically moved to abut the upper surface of the stage 2. Based on data on the light received by the light sensing unit 1b, the position of the mounting surface 2a of the stage 2 is detected, and the reference height of the mounting surface is set.

Then, the height data on the nozzle surface 4a is acquired by means of the line sensor 11 (ST2), and the nozzle 4 is moved based on data including the height data on the mounting surface 2a and nozzle surface 4a, set gap value G1, thickness t1 of the substrate W, etc. (ST3).

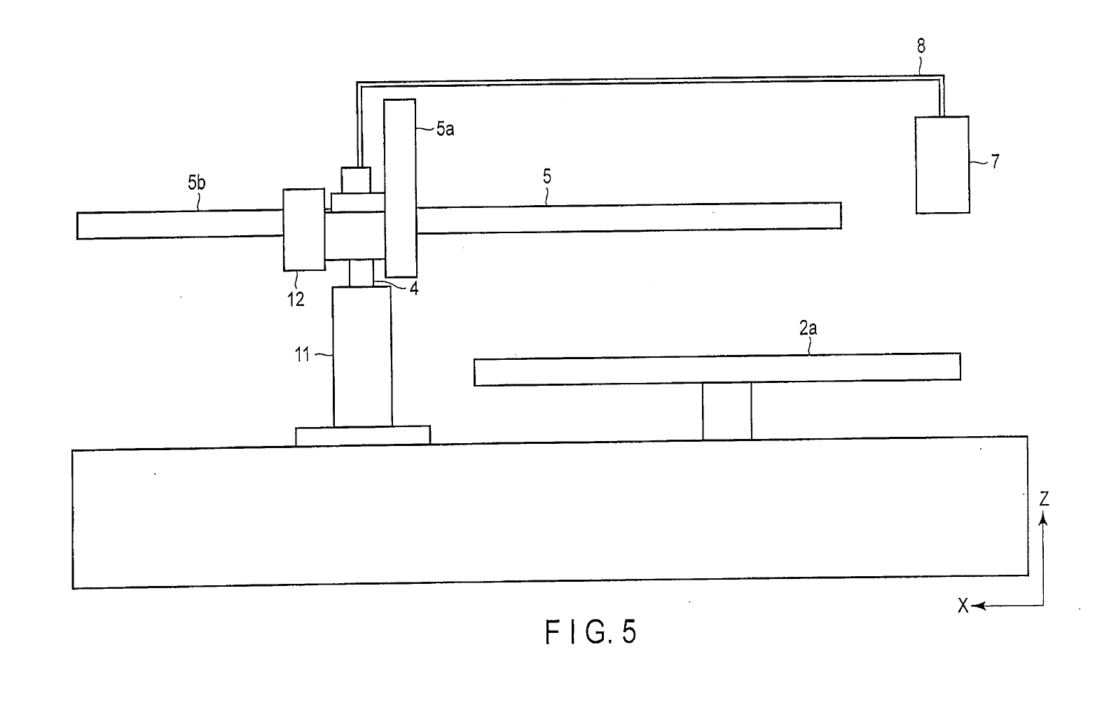

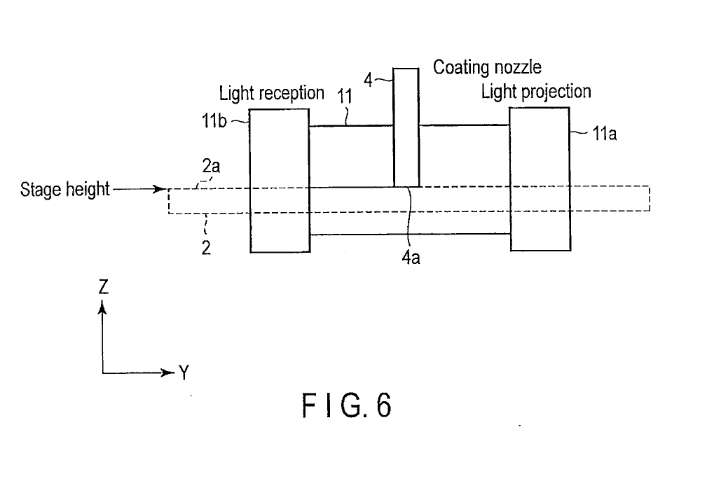

As shown in FIGS. 5 and 6, for example, the movement mechanism 5 is first activated to move the nozzle 4 so that the nozzle surface 4a is flush with the mounting surface 2a of the stage 2. As this is done, light is emitted from the light projecting unit 11a with the nozzle 4 located within the measurement range between the light projecting and sensing units 11a and 11b. Based on the data on the light acquired by the light sensing unit 11b, moreover, the position of the nozzle surface 4a is detected for positional alignment. Then, movement data on the movement mechanism 5 is recorded by the control unit 10.

Further, the adjustment substrate W2 as thick as the substrate W is set on the stage 2, and a Z-direction target position of the nozzle surface 4a is calculated based on thickness t1 of the substrate W, set gap value G1, etc. Based on the result of this calculation, the movement mechanism 5 is activated to move the nozzle 4 in the Z-direction. For example, the nozzle 4 is moved upward from the position where the nozzle surface 4a is flush with the mounting surface 2a for a distance equivalent to the sum of thickness t1 of the substrate W and set height G2 for a sensor reference value. Thereupon, the nozzle surface 4a is set in the Z-direction target position (or at a target height) at an arbitrary point on the substrate W. When this is done, travel data provided by the movement mechanism 5 is loaded into the control unit 10.

Then, the displacement sensor 12, along with the nozzle 4 set by the movement mechanism 5, is moved in an XYZ-space to a measurement position where it can measure a displacement of the mounting surface 2a. The sensor 12 is moved in the Z-direction by relative movement means (for movement relative to the nozzle) so that a gap setting range is within the measurement range. When this is done, travel data provided by the movement mechanism 5 is loaded into the control unit 10.

In this state, displacement G2 from the displacement sensor 12 to the adjustment substrate W2 is measured by the sensor 12 (ST4) and set as the sensor reference value (ST5). Thus, the sensor reference value is set in consideration of the vertical positional relationship between the displacement sensor 12 and nozzle surface 4a in the coating apparatus 1. The adjustment substrate W2 is removed after the sensor reference value is settled.

Further, the temperature of the nozzle 4 is measured by the temperature sensor 13 and loaded as reference temperature Tb into the control unit 10 (ST6).

Then, the substrate W as an object to be coated is introduced onto the stage 2 by a transport system, such as a robot handling system (ST7). The substrate W is secured on the stage 2 by the suction mechanism. Based on the sensor reference value determined in ST5, the vertical positions of the sensor 12 and nozzle 4 are adjusted by the movement mechanism 5, which integrally comprises the sensor 12 and nozzle 4 (ST8). When this is done, the movement mechanism 5 adjusts the distance from the sensor 12 to an upper surface Wa of the substrate W to G2.

Subsequently, a correction process is performed. In the correction process, temperature Tm of the nozzle 4 is first acquired by temperature sensing means (ST9). Based on reference temperature Ti set in ST6, thereafter, vertical correction value ΔZ is calculated in consideration of thermal expansion (ST10), and the nozzle 4 is moved for distance ΔZ in the Z-axis direction by the Z-axis movement mechanism 5a (ST11). In doing this, for example, previously measured reference temperature Ti and a data table for the nozzle expansion are stored in advance in the control unit 10, and the correction value is calculated using data obtained by calculating the nozzle expansion according to the data table. For example, correction value ΔZ is given by:

ΔZ=α(Tm−Ti)·L, (1)

where α is the coefficient of linear expansion; Tm, the measured temperature; Ti, the reference temperature; and L, the nozzle under-neck length.

For example, coefficient of linear expansion α is determined by the material of the nozzle 4. In the present embodiment, the nozzle 4 is made of, for example, PEEK, whose coefficient of linear expansion α is 50×10⁻⁶/° C.

Distance G3 from the displacement sensor 12 to the upper surface Wa of the substrate W is equal to G2+ΔZ.

Thus, the distance from the sensor 12 can be made greater than uncorrected distance G2 by a margin equivalent to length ΔZ of downward thermal expansion of the nozzle 4 due to temperature change. In this way, the distance between the nozzle 4 and the upper surface Wa of the substrate W is adjusted to a desired value based on consideration of the thermal expansion of the nozzle.

Then, the coating process is performed (ST12). In the coating process, the stage 2 is rotated by the rotation mechanism 3 so that the substrate W thereon is rotated. In this state, the coating nozzle 4, along with the Z-axis movement mechanism 5a, is moved at a uniform velocity in the X-axis direction from an origin position or the center of the substrate W, that is, from the center of the substrate W toward the outer periphery, by the X-axis movement mechanism 5b.

At this time, the supply pump is activated to supply the coating material, whereupon the coating nozzle 4 moves as it continuously discharges the material through the tip 4a onto the upper surface of the substrate W, thereby spirally applying the material to the substrate surface (spiral coating). Thus, the coating film M is formed on the upper surface Wa of the substrate W.

When the coating film M is formed in a predetermined area on the substrate W, the coating is finished and the substrate is removed (ST13). Thereafter, the coating nozzle 4 is raised by the Z-axis movement mechanism 5a, whereupon the coating process ends. Then, the processing of ST7 to ST13 is repeatedly performed to coat a fixed number of substrates (ST14), whereupon the processing ends.

According to the spiral coating apparatus and spiral coating method of the present embodiment, high-precision gap adjustment can be achieved in consideration of the height data on the nozzle surface 4a. According to the embodiment described above, moreover, the vertical position of the mounting surface 2a of the stage 2 can be highly precisely aligned with that of the nozzle surface 4a by means of the common line sensor 11.

According to the above-described embodiment, furthermore, correction is performed in consideration of thermal expansion of the nozzle 4 due to temperature change, so that positioning can be achieved more precisely.

### Second Embodiment

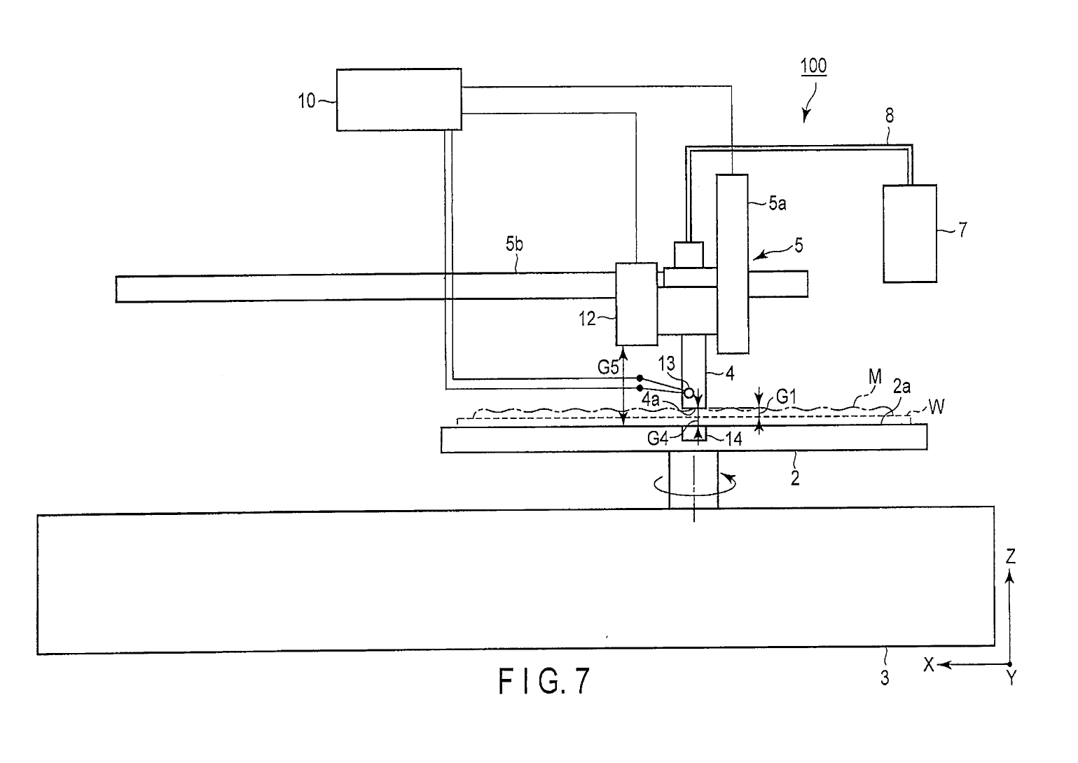

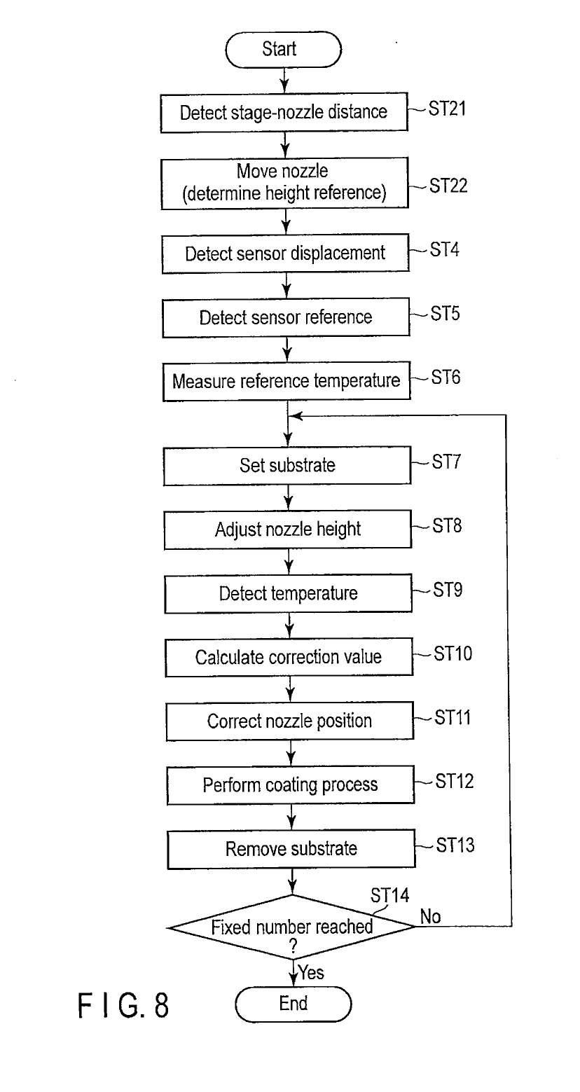

A spiral coating apparatus 100 and a spiral coating method according to a second embodiment will now be described with references to FIGS. 7 and 8. The present embodiment differs from the first embodiment only in that a displacement sensor embedded in a stage 2 is used as a position detection unit for detecting a nozzle position, so that a description of common parts is omitted.

In the spiral coating apparatus 100 according to the present embodiment, as shown in FIG. 7, a displacement sensor 14 is embedded in a predetermined position in a mounting surface 2a of the stage 2. The displacement sensor 14 is, for example, a reflective laser sensor, which measures clearance G4 from the mounting surface 2a of the stage 2 to a nozzle surface 4a of a coating nozzle 4. Height data on the nozzle surface 4a can be acquired in this way.

According to the spiral coating method of the present embodiment, as shown in FIG. 8, clearance G4 to the nozzle surface 4a is measured by means of the displacement sensor 14 as the nozzle 4 is moved (ST21). Based on clearance G4 and thickness t1 of a substrate W, the position of the nozzle 4 is adjusted so that the gap between the nozzle surface 4a and an upper surface Wa of the substrate W is equal to preset gap value G1 (ST22). As in the process of ST4 and the subsequent processes of the first embodiment, thereafter, distance G5 from the displacement sensor 12 that behaves integrally with the nozzle 4 to the mounting surface 2a of the mounting surface 2a of the stage 2 opposite thereto is measured, and a sensor reference value is set. The operation in the process of ST4 and the subsequent processes is the same as that of the first embodiment.

According to the spiral coating apparatus 10 and spiral coating method of the present embodiment, the clearance from the mounting surface 2a of the stage 2 to the nozzle surface 4a is determined by means of the displacement sensor 14 on the side of the stage 2 that does not move in the Z-direction, and the sensor reference is set based on the measured value. Thus, high-precision gap control can be achieved by virtue of not being easily affected by the reproducibility of the movement of the nozzle 4 that is movable in the Z-direction.

### Third Embodiment

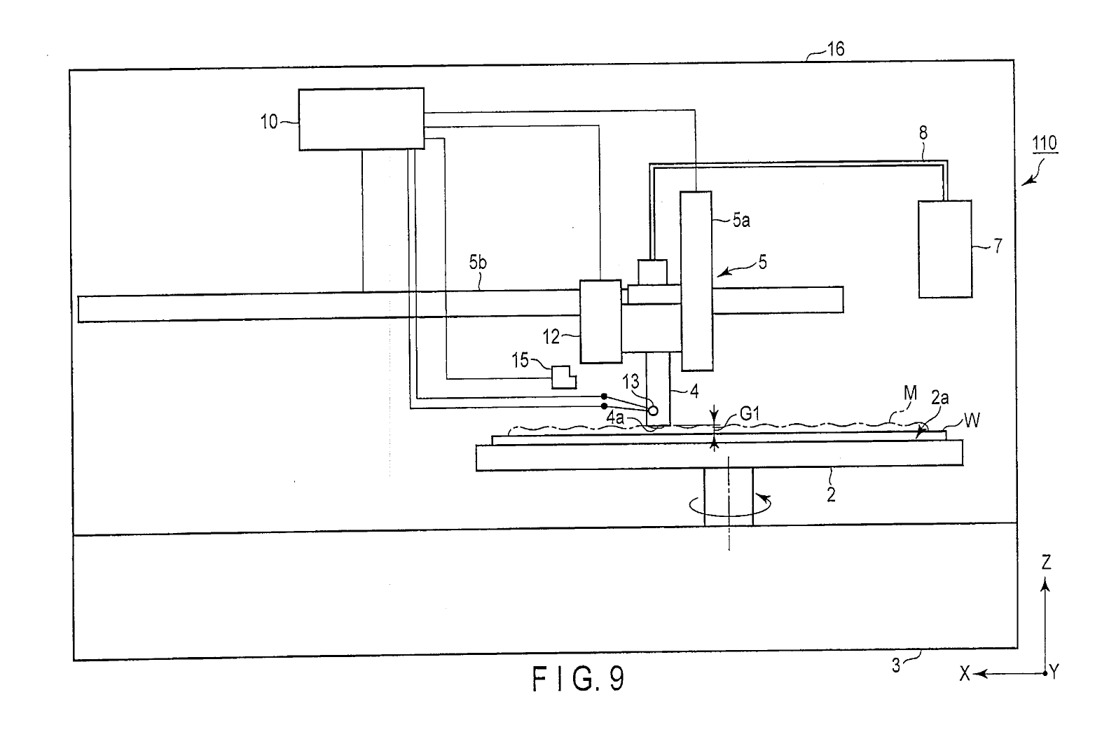

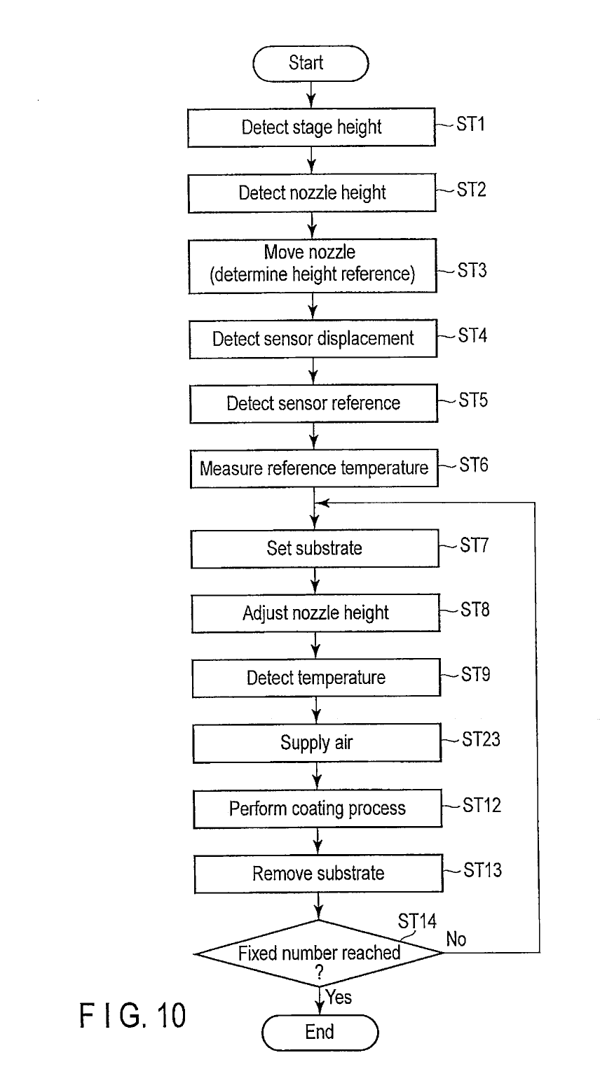

A spiral coating apparatus 110 and a spiral coating method according to a third embodiment will now be described with references to FIGS. 9 and 10.

As shown in FIG. 9, the spiral coating apparatus 110 according to the present embodiment comprises a blower system 15 that keeps the peripheral temperature of the nozzle 4 constant. The blower system 15 is formed of, for example, a duct mechanism for blowing temperature-controlled air and is located beside the nozzle 4. The blower system 15 blows air toward the nozzle 4 under the control of a control unit 10, thereby adjusting the temperature inside a chamber 16 that constitutes the shell of the coating apparatus 110.

Conditions, such as the air temperature, quantity, etc., are determined according to, for example, the temperature of the nozzle 4 measured by the temperature sensing unit 13. For example, air is blown under such conditions that the temperature of the nozzle 4 is kept at reference temperature Ti.

In the spiral coating method according to the present embodiment, as shown in FIG. 10, the process of ST9 and its preceding processes are performed in the same manner as in the first embodiment. In place of the nozzle position correction in ST10 and ST11, thereafter, air of a predetermined temperature is supplied toward nozzle 4 by the blower system 15 (ST23) so that the temperature in the coating apparatus 110 is kept at a preset reference temperature. In this way, the size of the nozzle 4 is restored to its reference value and the nozzle is prevented from being affected by thermal expansion.

According to the coating apparatus 110 and coating method of the present embodiment, the size of the nozzle 4 is maintained by a blast of air of a predetermined temperature such that the nozzle can be prevented from being affected by thermal expansion and the gap can be highly precisely adjusted.

In the first to third embodiments described herein, for example, the wall temperature of the nozzle 4 is detected by means of the temperature sensor 13 attached to the flank of the nozzle. However, the number of temperature sensors and the object of temperature measurement are not limited to the above-described embodiments. For example, a plurality of temperature sensors may be installed in a plurality of positions, and the object of temperature control is not limited to the sidewall of the nozzle 4 and may alternatively be the movement mechanism 5 that supports the nozzle 4 or the supply unit 7 stored with the material. If a plurality of temperature sensors are installed, they are used to measure the temperatures of the nozzle, the movement mechanism 5, and a baseplate that supports the rotation mechanism 3. Based on measured data, thermal expansions ΔZ1, ΔZ2 and ΔZ3 of the nozzle, movement mechanism, and baseplate are calculated, whereby the relative expansion of the nozzle and substrate W in the Z-direction is calculated (ΔZ=ΔZ1+ΔZ2+ΔZ3).

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A spiral coating apparatus comprising:
a stage comprising a mounting surface on which an object to be coated is placed;
a rotation mechanism configured to rotate the stage in a rotational direction along the mounting surface;
a coating nozzle configured to discharge a material onto the object to be coated on the stage, thereby coating the object;
a movement mechanical unit which enables the stage and the coating nozzle to relatively move in a cross direction across the rotational direction along the mounting surface and in the direction of the axis of the rotation;
a nozzle position detection unit configured to acquire positional data on a bottom surface of the coating nozzle in the direction of the axis of the rotation; and
a position adjustment unit configured to adjust the positions of the coating nozzle and the mounting surface in the direction of the axis based on the positional data on the coating nozzle.

2. The spiral coating apparatus of claim 1, wherein the nozzle position detection unit comprises a displacement sensor located on the stage and configured to measure a displacement to a tip of the coating nozzle.

3. The spiral coating apparatus of claim 1, wherein the nozzle position detection unit comprises a line sensor located beside the stage and configured to detect the position of the tip of the coating nozzle in the direction of the axis.

4. The spiral coating apparatus of claim 3, wherein the movement mechanical unit comprises a stage displacement sensor disposed integrally with the coating nozzle and configured to move together with the coating nozzle and measure a distance to the mounting surface while facing the stage, and the position adjustment unit performs the position adjustment based on the positional data on the nozzle, data on the movement of the nozzle by the movement mechanical unit, and the distance to the mounting surface measured by the stage displacement sensor.

5. The spiral coating apparatus of claim 4, further comprising a temperature sensing unit configured to detect the temperature of the nozzle, wherein the position adjustment unit calculates an amount of thermal expansion of the nozzle based on the temperature of the nozzle and performs a correction process to correct the vertical positional relationship between the nozzle and the mounting surface.

6. A spiral coating apparatus comprising:
a stage comprising a mounting surface on which an object to be coated is placed;
a rotation mechanism configured to rotate the stage in a rotational direction along the mounting surface;
a coating nozzle configured to discharge a material onto the object to be coated on the stage, thereby coating the object;
a movement unit which enables the stage and the coating nozzle to relatively move in a cross direction across the rotational direction along the mounting surface;
a temperature sensing unit configured to detect the temperature of the coating nozzle; and
a position adjustment unit configured to calculate an amount of thermal expansion of the coating nozzle based on the temperature of the nozzle and correct the axial positional relationship between the nozzle and the mounting surface.

7. A spiral coating apparatus comprising:
a stage comprising a mounting surface on which an object to be coated is placed;
a rotation mechanism configured to rotate the stage in a rotational direction along the mounting surface;
a coating nozzle configured to discharge a material onto the object to be coated on the stage, thereby coating the object;
a movement mechanical unit which enables the stage and the coating nozzle to relatively move in a cross direction across the rotational direction along the mounting surface;
a temperature sensing unit configured to detect the temperature of the coating nozzle; and
a temperature control unit configured to feed a gas of a predetermined temperature to an installation atmosphere for the nozzle, thereby adjusting the temperature of the nozzle.

8. The spiral coating apparatus of claim 6, wherein the temperature sensing means is located in a plurality of positions and measures the temperature of the coating nozzle, a support mechanism supporting the coating nozzle, and/or the material supplied to the coating nozzle.
